(19) United States
(12) Patent Application Publication
(10) Pub. No.: US 2009/0194902 A1
(43) Pub. Date: Aug. 6, 2009

(54) Bumper Back Beam For Vehicle and Molding Method Thereof

(75) Inventors: Jae Shik LEE, Cheonan-si (KR); Sang Wook Lee, Asan-si (KR); Woo Youn Geum, Suwon-si (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); SAMBARK LFT CO., LTD., Asan-si, (KR)

(21) Appl. No.: 12/324,299

(22) Filed: Nov. 26, 2008

(30) Foreign Application Priority Data
Feb. 1, 2008 (KR) 10-2008-0010436

(51) Int. Cl. B29C 47/00; B29C 45/14

(52) U.S. Cl. 264/211.12; 264/257

(57) ABSTRACT

Disclosed herein is a method of molding a bumper back beam for a vehicle and the bumper back beam manufactured using the method. The method of molding the bumper back beam includes: preparing a lattice mat and long fiber pellets as raw materials, introducing the lattice mat into a die, supplying the long fiber pellets into the die and then injection-molding a bumper back beam from the lattice mat and long fiber pellets at low pressures and separating the injection-molded bumper back beam from the die.

### CROSS-REFERENCE TO RELATED APPLICATION

The present application claims priority to Korean Application No. 10-2008-0010436 filed Feb. 1, 2008, the entire contents of which application is incorporated herein for all purposes by this reference.

### BACKGROUND OF THE INVENTION

1. Field of the Invention

The present invention relates to a bumper back beam for a vehicle and a method of molding the same.

2. Description of Related Art

A bumper back beam for a vehicle is installed in a bumper such that it can absorb an impact at the time of a vehicle collision. Such a bumper back beam must be able to absorb an impact efficiently and must have suitable durability.

For instance, a conventional bumper back beam is manufactured by introducing a glass mat into a press die, putting glass fiber or polypropylene resin into the press die, layering them, and then press-molding them at high pressure.

However, since a conventional bumper back beam is manufactured through a high-pressure press-molding process, it cannot be molded integrally with ribs, mounting holes and brackets for reinforcing the bumper back beam. Therefore, there are problems in that it is difficult to increase the strength of the bumper back beam, and in that additional post-processes are required in order to form the ribs, mounting holes and brackets in the bumper back beam.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a bumper back beam for a vehicle, which is molded integrally with ribs, mounting holes and brackets for reinforcing the bumper back beam, and a method of molding the same.

In an aspect of the present invention, a method of molding a bumper back beam, may include preparing a lattice mat and long fiber pellets as raw materials, introducing the lattice mat into a die, supplying the long fiber pellets into the die and then injection-molding the bumper back beam from the lattice mat and long fiber pellets at low pressure, and/or separating the injection-molded bumper back beam from the die.

The preparing of the lattice mat may include mixing a polypropylene resin with an additive, melting the mixture to form a fluid mixture of the polypropylene resin and the additive, extruding the mixture from an extruder, impregnating a pre-molded glass fiber with the extruded mixture, winding the glass fiber impregnated with the extruded mixture, and/or weaving the wound glass fiber impregnated with the extruded mixture in a form of a lattice to fabricate the lattice mat. The lattice mat may be formed by impregnating a pre-molded glass fiber with a polypropylene resin.

The preparing of the long fiber pellets may include mixing a polypropylene resin with an additive, melting the mixture to form a fluid mixture of the polypropylene resin and the additive, extruding the mixture from an extruder, impregnating a pre-molded glass fiber with the extruded mixture, and/or cutting the glass fiber impregnated with the extruded mixture to fabricate the long fiber pellets. The long fiber pellets may be formed by impregnating a pre-molded glass fiber with a polypropylene resin.

In the introducing the lattice mat, the lattice mat may be disposed in a cavity in the die, the cavity having a shape corresponding to a shape of the bumper back beam.

The bumper back beam for a vehicle is manufactured using the above method.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic view illustrating an exemplary method of molding a bumper back beam for a vehicle according to the present invention.

FIG. 2 is a flowchart illustrating an exemplary method of molding a bumper back beam for a vehicle according to the present invention.

FIG. 3A is a schematic view illustrating a process of preparing a lattice mat in the exemplary method of molding a bumper back beam for a vehicle according to the present invention.

FIG. 3B is a schematic view illustrating a process of preparing long fiber pellets in the exemplary method of molding a bumper back beam for a vehicle according to the present invention.

FIG. 4 is a sectional view showing the state in which the bumper back beam, molded using the exemplary method of molding a bumper back beam for a vehicle according to the present invention, is combined with a foamed material.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

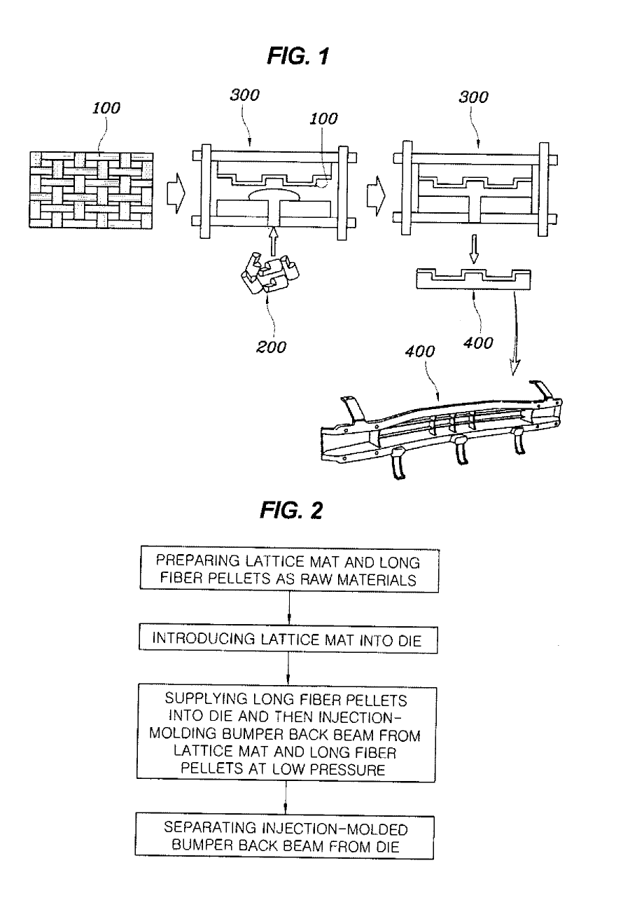

As shown in FIGS. 1 and 2, a method of molding a bumper back beam according to the present invention includes: preparing a lattice mat 100 and long fiber pellets 200, which are formed by impregnating a glass fiber with a polypropylene resin, as raw materials; introducing the lattice mat 100 into a die 300; supplying the long fiber pellets 200 into the die 300 and then injection-molding the lattice mat 100 and long fiber pellets 200 into a bumper back beam 400 at low pressure; and separating the injection-molded bumper back beam 400 from the die 300. Further, the bumper back beam for a vehicle according to the present invention is manufactured using the above method.

The preparing of the raw materials includes: fabricating the lattice mat 100; and fabricating the long fiber pellets 200.

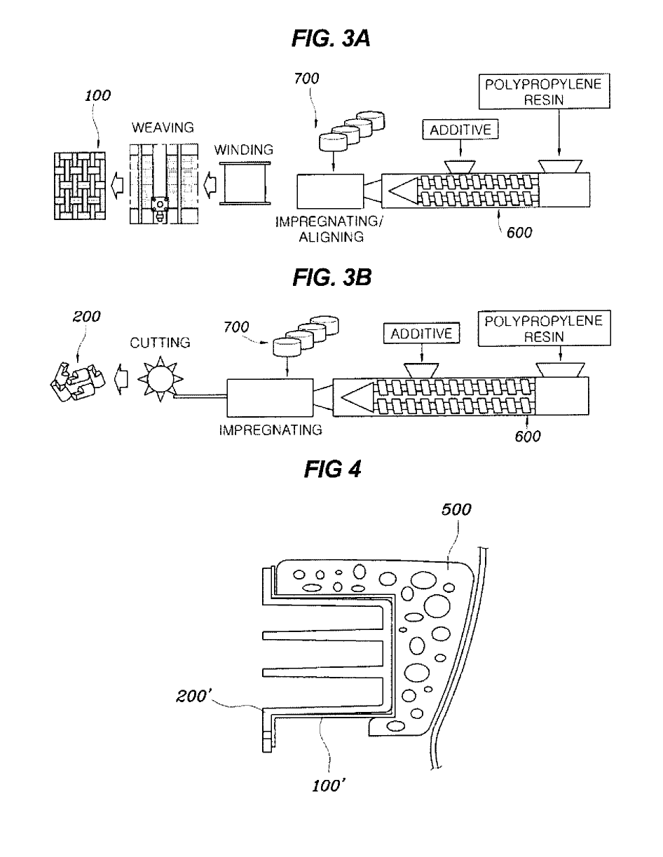

For example, as shown in FIG. 3A, in the fabricating of the lattice mat, a polypropylene resin and an additive are introduced into an extruder 600, mixed with each other, heated, and then melted to form a fluid mixture of the polypropylene resin and additive. Subsequently, the mixture of the polypropylene resin and additive is continuously extruded and simultaneously pressed.

After the mixture of the polypropylene resin and additive is extruded from the extruder 600, the extruded mixture is impregnated in a pre-molded glass fiber 700 and is then wound. In this case, the pre-molded glass fiber 700 has a long fiber shape.

Thereafter, the wound glass fiber impregnated with the extruded mixture is woven, thereby fabricating the polypropylene lattice mat 100.

Here, it is preferred that the lattice mat 100 be fabricated to have the same area as the bumper back beam 400 that is to be molded. The lattice mat 100 fabricated in this way serves to increase the strength of the bumper back beam 400 injection-molded with the long fiber pellets 200.

As shown in FIG. 3B, in the fabricating of the long fiber pellets, a polypropylene resin and an additive are introduced into an extruder 600, mixed with each other, heated, and then melted to form a fluidized mixture of the polypropylene resin and additive. Subsequently, the mixture of the polypropylene resin and additive is continuously extruded and simultaneously pressed.

After the mixture of the polypropylene resin and additive is extruded from the extruder 600, the extruded mixture is impregnated in a pre-molded glass fiber 700, and then the glass fiber impregnated with the extruded mixture is cut, thereby fabricating the propylene long fiber pellets 200.

When the propylene lattice mat 100 and the propylene long fiber pellets 200 are prepared, at first the prepared propylene lattice mat 100 is introduced into a cavity in a die 300 for molding a bumper back beam 400. In this case, the lattice mat 100 is disposed in the cavity in the die 300, the cavity having a shape corresponding to the shape of the bumper back beam.

After the lattice mat 100 is introduced into the cavity in the die 300, the prepared polypropylene long fiber pellets 200 are supplied into the cavity in the die 300, and are then injection-molded at low pressure. That is, when the lattice mat 100 is introduced into the cavity in the die 300 and then the cavity in the die 300 is closed, the polypropylene long fiber pellets 200 are introduced into the cavity in the die 300, heated, melted, solidified and then cured, thereby manufacturing a bumper back beam product.

As shown in FIG. 4, the bumper back beam manufactured through the above processes, including a lattice mat 100′ and long fiber pellets 200′, constitutes a bumper for a vehicle together with foamed material 500.

As described above, the present invention is advantageous in that the weight of a bumper back beam product can be reduced and the molding cycle time for producing the bumper back beam can also be decreased because parts for reinforcing the bumper back beam, such as ribs, mounting holes, brackets, and the like, are molded integrally with the bumper back beam. Further, the present invention is advantageous in that additional post-processes for forming the parts for reinforcing the bumper back beam, such as ribs, mounting holes, brackets, and the like, in the bumper back beam are not required, and in that the production cost thereof is reduced.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of molding a bumper back beam, comprising:
preparing a lattice mat and long fiber pellets as raw materials;
introducing the lattice mat into a die;
supplying the long fiber pellets into the die and then injection-molding the bumper back beam from the lattice mat and long fiber pellets at low pressure; and
separating the injection-molded bumper back beam from the die.

2. The method of molding a bumper back beam according to claim 1, wherein the preparing of the lattice mat comprises:
mixing a polypropylene resin with an additive;
melting the mixture to form a fluid mixture of the polypropylene resin and the additive;
extruding the mixture from an extruder;
impregnating a pre-molded glass fiber with the extruded mixture;
winding the glass fiber impregnated with the extruded mixture; and
weaving the wound glass fiber impregnated with the extruded mixture in a form of a lattice to fabricate the lattice mat.

3. The method of molding a bumper back beam according to claim 2, wherein the lattice mat is formed by impregnating a pre-molded glass fiber with a polypropylene resin.

4. The method of molding a bumper back beam according to claim 1, wherein the preparing of the long fiber pellets comprises:
mixing a polypropylene resin with an additive;
melting the mixture to form a fluid mixture of the polypropylene resin and the additive;
extruding the mixture from an extruder;
impregnating a pre-molded glass fiber with the extruded mixture; and
cutting the glass fiber impregnated with the extruded mixture to fabricate the long fiber pellets.

5. The method of molding a bumper back beam according to claim 4, wherein the long fiber pellets are formed by impregnating a pre-molded glass fiber with a polypropylene resin.

6. The method of molding a bumper back beam according to claim 1, wherein, in the introducing the lattice mat, the lattice mat is disposed in a cavity in the die, the cavity having a shape corresponding to a shape of the bumper back beam.

7. A bumper back beam, manufactured by the method of claim 1.
